(19) United States
(12) Patent Application Publication
(10) Pub. No.: US 2011/0064515 A1
(43) Pub. Date: Mar. 17, 2011

(54) ANCHOR AND SPLICE PLATE ASSEMBLY FOR AXIALLY SPLIT COMPOSITE DUCT OR PRESSURE VESSEL

(75) Inventors: Curtis J. Ruckey, Windsor Locks, CT (US); Francis R. Moon, Granby, CT (US)

(73) Assignee: UNITED TECHNOLOGIES CORPORATION, Hartford, CT (US)

(21) Appl. No.: 12/558,235

(22) Filed: Sep. 11, 2009

(51) Int. Cl. F16B 5/00; B23P 11/00

(52) U.S. Cl. 403/179; 403/217; 29/525.01

(57) ABSTRACT

An assembly includes first and second shell members. An anchor plate includes a body portion, first and second arrays of fastener openings, and anchor plate attachment features extending from a first side of the body portion and each having a fastener opening. Inserts are positioned within each fastener opening of the first array and the second array. A first set of fasteners is secured through the first array of fastener openings in the anchor plate, the first shell member and the splice plate and engaged with a corresponding one of the inserts. A second set of fasteners is secured through the second array of fastener openings in the anchor plate, the second shell member and the splice plate and engaged with a corresponding one of the inserts. A third set of fasteners is secured through the fastener openings of the anchor plate attachment features and the first shell member.

### STATEMENT OF GOVERNMENT INTEREST

This invention was made with U.S. Government support under Contract No. N00019-02-C-3003. The Government has certain rights in this invention.

### BACKGROUND

The present invention relates generally to joint assemblies suitable for use with a segmented duct or pressure vessel.

Ducts and pressure vessels are often assembled from a plurality of discrete segments. For example, bypass ducts for gas turbine engines are often made up of axially split duct segments that are secured together at structural joints using bolts and splice plates. However, bypass duct design and assembly presents a number of problems. Access to interior regions of an assembled bypass duct is limited, which reduces access to bolts or other fasteners from the inside of the duct. A number of blind fastener designs are known in the art that allow fasteners to tightened and loosened from exterior locations alone. But those prior art designs have flaws and limitations. For example, certain blind fastener means like caged bolts and nut plates have reliability issues, and if they become worn or damaged during use may make it difficult or impossible to remove. For instance, after use, a caged bolt may begin to spin due to deformation of its retaining cage, making it impossible to loosen a nut attached to the bolt from the exterior of the duct without access to the bolt from inside the duct. Moreover, drilling out a failed caged bolt with a retaining cage that has failed is difficult without access to the interior of the duct. Efforts have been made to utilize composite materials to form bypass duct segments that are lighter (i.e., have less mass) than those made from metallic materials. However, composite materials further limit efforts to structurally join duct segments. For example, it is difficult if not impossible to form composite materials into flanges to make bolted connections between parts. In addition, composite materials themselves are generally unsuitable for forming threads to accept threaded bolts. Blind fastener means like ovalized threaded grommets with threaded inserts can be secured in the composite material, but require a great deal of parent material of the duct to be removed for grommet insertion, in some cases four to five times wider than a diameter of a corresponding bolt to be engaged with the grommet. Extensive parent material removal leads to localized weaknesses in the duct, which present a risk of cracking and other damage. Such grommets are also relatively expensive, heavy, and time consuming to install.

The types of problems discussed above all frustrate and complicate efforts to perform maintenance on the bypass duct and other components of the gas turbine engine. Therefore, it is desired to provide a joint assembly for use with ducts and pressure vessels that is relative lightweight, reliable, and easy to install.

### SUMMARY

An assembly according to the present invention includes first and second shell members. An anchor plate includes a body portion, first and second arrays of fastener openings, and anchor plate attachment features extending from a first side of the body portion and each having a fastener opening. Inserts are positioned within each fastener opening of the first array and the second array. A first set of fasteners is secured through the first array of fastener openings in the anchor plate, the first shell member and the splice plate and engaged with a corresponding one of the inserts. A second set of fasteners is secured through the second array of fastener openings in the anchor plate, the second shell member and the splice plate and engaged with a corresponding one of the inserts. A third set of fasteners is secured through the fastener openings of the anchor plate attachment features and the first shell member.

### BRIEF DESCRIPTION OF THE DRAWINGS

FIG. 1 is a schematic view of a gas turbine engine.

FIG. 2 is a perspective view of one embodiment of a joint assembly according to the present invention.

FIG. 3 is a cross-sectional view of the joint assembly, taken along line 3-3 of FIG. 2.

FIG. 4 is an elevation view of an additional embodiment of the joint assembly according to the present invention.

FIG. 5 is a cross-sectional view of the additional embodiment of the joint assembly, taken along line 5-5 of FIG. 4.

### DETAILED DESCRIPTION

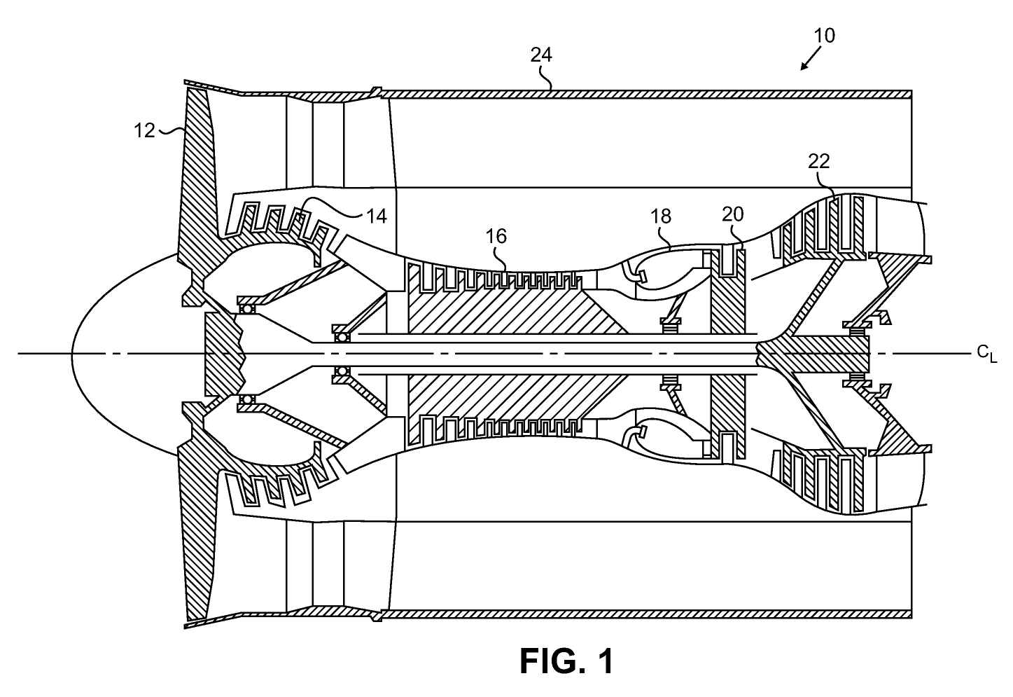

FIG. 1 is a schematic cross-sectional view of a gas turbine engine 10 that includes a fan section 12, a low-pressure compressor (LPC) section 14, a high-pressure compressor (HPC) section 16, a combustor section 18, a high-pressure turbine (HPT) section 20, and a low-pressure turbine (LPT) section 22. A centerline C_{L} is defined by the engine 10. A generally annular bypass duct 24 extends aftward from the fan section 12, and is positioned radially outward from a primary flowpath through the LPC section 14, the HPC section 16, the combustor section 18, the HPT section 20 and the LPT section 22. Airflow through the bypass duct 24 generated by the fan section 12 during operation of the engine 10 helps provide thrust. It should be noted that the illustrated embodiment of the gas turbine engine 10 is provided merely by way of example and not limitation. Aspects of the present invention can be applied to gas turbine engines of any configuration, such as low bypass ratio configurations. The basic operation of gas turbine engines is well known, and therefore further discussion here is unnecessary.

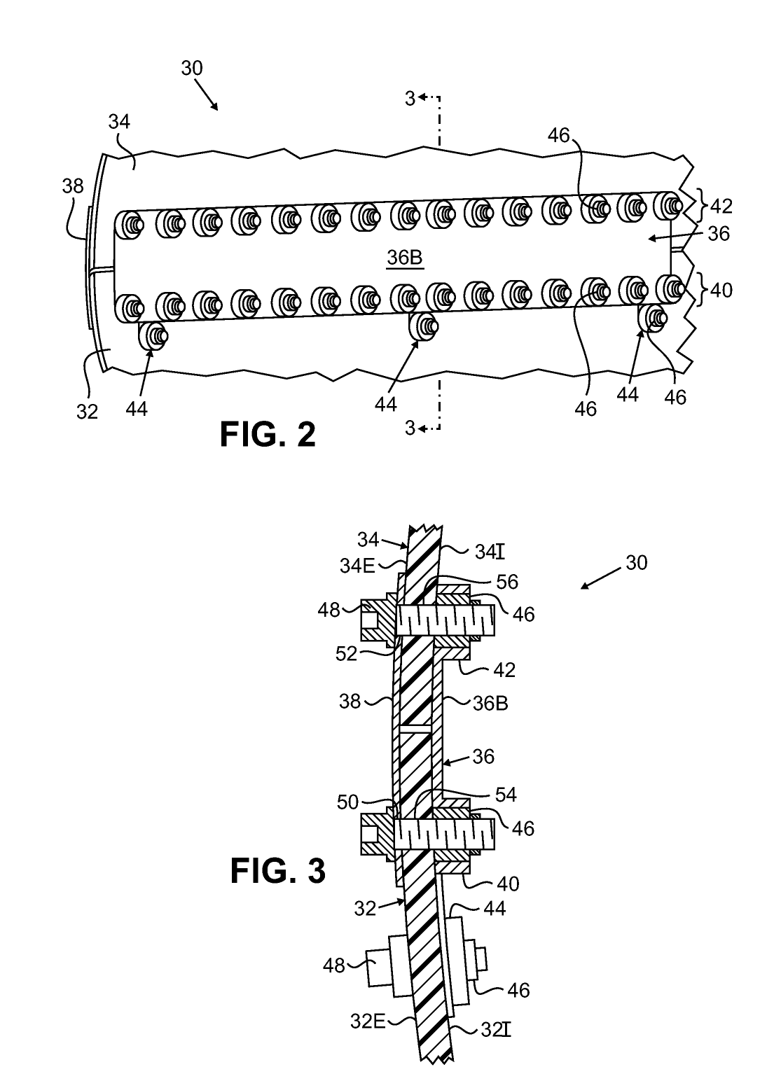

FIG. 2 is a perspective view of one embodiment of a joint assembly 30 of the bypass duct 24, and FIG. 3 is a cross-sectional view of the joint assembly 30 taken along line 3-3 of FIG. 2. In the illustrated embodiment, the assembly 30 includes a first duct segment (or shell member) 32, a second duct segment (or shell member) 34, an anchor plate 36, and a splice plate 38. The first and second duct segments 32 and 34 define adjacent portions of the bypass duct 24 that are axially split from each other (i.e., when assembled together forming a split line that is substantially parallel to the centerline C_{L}). The first duct segment 32 has an exterior surface 32E and an opposite interior surface 32I. Likewise, the second duct segment 34 has an exterior surface 34E and an opposite interior surface 34I.

In the illustrated embodiment, the anchor plate 36 is positioned against adjacent portions of the interior surfaces 32I and 34I of the first and second duct segments 32 and 34, respectively. The anchor plate 36 includes a body portion 36B having a substantially rectangular perimeter. A first array of bosses (or collars) 40 and a second array of bosses (or collars) 42 are each arranged in a row extending from the body 36B of the anchor plate 36. Each of the bosses 40 and 42 has a substantially cylindrical shape with a central opening in the illustrated embodiment. The central openings of the bosses 40 and 42 are optionally threaded. The first array of bosses 40 is arranged at a portion of the interior surface 32I of the first duct segment 32, and the second array of bosses 42 is spaced apart of the first array of bosses 40 and arranged at a portion of the interior surface 34I of the second duct segment 34.

A plurality of attachment features 44 extend from one edge of the body portion 36B of the anchor plate 36 in the illustrated embodiment. Each attachment feature 44 has a substantially circular perimeter and defines a central opening. The central openings of the attachment features 44 are optionally threaded.

An insert 46 is secured within each opening of the first and second arrays of bosses 40 and 42 and the attachment features 44 to provide a rotationally-fixed blind engagement means between the anchor palate 36 suitable fasteners 48 (e.g., threaded bolts). The inserts 46 can each be configured as a cylinder with threads on both interior and exterior surfaces, with key members positioned along channels formed through the threads on the exterior surface of the insert that are driven down along the channels and through parent material of the corresponding threads of the boss 40 or 42 or attachment feature 44 in which the insert 46 is positioned to rotationally lock the insert 46 relative to the anchor plate 36. Such a keyed configuration of the inserts 46 provides a relatively reliable and stable rotationally fixed mount. In one embodiment, the inserts 46 are Tridair® brand Keensert® inserts (available from Alcoa Fastening Systems, Torrance, Calif.). Other types of inserts can be utilized in alternative embodiments.

The splice plate 38 is positioned generally opposite the anchor plate 36 against adjacent portions of the exterior surfaces 32E and 34E of the first and second duct segments 32 and 34, respectively. The splice plate 38 can define a substantially rectangular perimeter, and can be sized commensurate with a size of the body portion 36B of the anchor plate 36. A first array of openings 50 and a second array of openings 52 are defined through the splice plate 38 (only one opening of each array 50 and 52 is visible in FIG. 2). The openings 50 and 52 are arranged to align with the central openings of the first and second arrays of bosses 40 and 42, respectively, of the anchor plate 36. The openings 50 and 52 can be circular, or can have other shapes to permit alignment adjustments. The fasteners 48 are engaged to secure the anchor plate 36 and the splice plate 38 together with the first and second duct segments 32 and 34.

In order to fabricate the assembly 30, the first and second duct segments 32 and 34, the anchor plate 36, and the splice plate 38 are provided. In one embodiment, the first and second duct segments 32 and 34 are each made of a fiber reinforced composite material, and the anchor plate 36 and the splice plate 38 are each made of metallic materials. Material of the anchor plate 36 can be removed in between the bosses 40 and 42 (e.g., by machining or other suitable processes) in order to reduce a thickness of the anchor plate 36 and thereby reduce a mass of the assembly 30. Next, the inserts 46 are secured to the anchor plate 36. The anchor plate 36 is then attached to the first duct segment 32 using the fasteners 48 engaged to the inserts 46 of the attachment features 44 through suitable openings through the first duct segment 32. In this way, the anchor plate 36 is secured to the first duct segment 32 in a desired position, allowing the anchor plate 36 to maintain its desired position even as access to interior surfaces 32I and 34I of the first and second duct segments 32 and 34 is limited or prevented.

Next, the second duct segment 34 is positioned adjacent to the first duct segment 32 in a desired configuration. The splice plate 38 is the positioned adjacent to the first and second duct segments 32 and 34. The fasteners 48 are then engaged between the first array of openings 50 in the splice plate 38 to the inserts 46 in the first array of bosses 40 of the anchor plate 36, and between the second array of openings 52 in the splice plate 38 to the insets 46 in the second array of bosses 42 of the anchor plate. The fasteners pass through first and second arrays of openings 52 and 54 in the first and second duct segments 32 and 34, respectively. This secures the anchor plate 36 and the splice plate 38 together with the first and second duct segments 32 and 34 to form the completed joint assembly 30. The finished joint assembly 30 provides structural support between the first and second duct segments 32 and 34. The fasteners 48 are secured in a blind engagement configuration. Because the inserts 46 are rotationally fixed relative to the anchor plate 36, the fasteners 48 can be engaged and disengaged (e.g., rotationally tightened and loosened) from a location proximate the exterior surfaces 32E and 34E of the first and second duct segments 32 and 34 alone, without requiring access to interior regions.

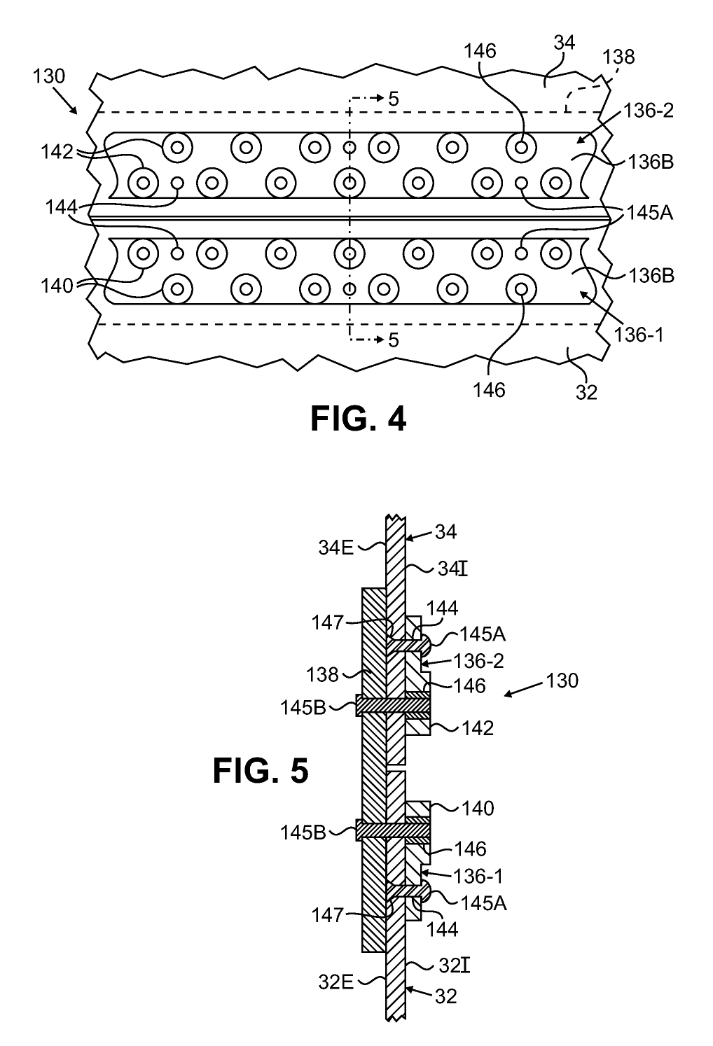

FIG. 4 is an elevation view of an additional embodiment of a joint assembly 130, and FIG. 5 is a cross-sectional view of the joint assembly 130 taken along line 5-5 of FIG. 4. The joint assembly 130 includes a first duct segment 32, a second duct segment 34, a first anchor plate 136-1, a second anchor plate 136-2, and a splice plate 138. The first anchor plate 136-1 is arranged adjacent to the interior surface 32I of the first duct segment 32, and the second anchor plate 136-2 is arranged adjacent to the interior surface 34I of the first duct segment 34. The splice plate 138 is positioned generally opposite the first and second anchor plates 136-1 and 136-2 against adjacent portions of the exterior surfaces 32E and 34E of the first and second duct segments 32 and 34, respectively.

The first and second anchor plates 136-1 and 136-2 each have a body portion 136B. The first anchor plate 136-1 includes a first array of bosses 140 extending from the body portion 136B, and the second anchor plate 136-2 includes a second array of bosses 142 extending from the body portion 136B. In the illustrated embodiment, the first and second arrays of bosses 140 and 142 are each arranged as a pair of parallel, offset rows. Each of the first and second anchor plates 136-1 and 136-2 further includes a plurality of attachment openings 144, which are arranged in an offset configuration in the illustrated embodiment.

Fabrication and assembly of the joint assembly 130 is generally similar to that described above with respect to the joint assembly 30. However, in the present embodiment, each of the first and second anchor plates 136-1 and 136-2 is secured to its respective first and second duct segment 32 and 34 using fasteners 145, such as rivets, positioned and engaged through the attachment openings 144. Fasteners 145B, such as conventional bolts, are then engaged between the splice plate 138 and the first and second anchor plates 136-1 and 136-2 in blind engagement to inserts 146 in the first and second arrays of bosses 140 and 142. In the illustrated embodiment, countersunk recesses 147 are provided at the respective exterior surfaces 32E and 34E of the each of the first and second duct segments 32 and 34 to accommodate portions of the fasteners 145, such that the fasteners 145 can be engaged while still allowing the splice plate 138 to be positioned substantially flush with the respective exterior surfaces 32E and 34E of the first and second duct segments 32 and 34.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims. For example, the present invention can be applied to nearly any duct or pressure vessel, such as pipes and conduits used for a variety of applications.

1. An assembly comprising:
a first shell member;
a second shell member positioned adjacent to the first shell member;
a splice plate extending across portions of both the first shell member and the second shell member;
an anchor plate located opposite the splice plate and extending across portions of both the first shell member and the second shell member, the anchor plate comprising:
a body portion;
a first array of fastener openings defined through the body portion;
a second array of fastener openings defined through the body portion; and
a plurality of anchor plate attachment features extending from a first side of the body portion and each having a fastener opening;
an insert positioned within each fastener opening of the first array and the second array, wherein each insert is rotationally locked relative to the anchor plate;
a first set of fasteners secured through the first array of fastener openings in the anchor plate, the first shell member and the splice plate and each engaged with a corresponding one of the inserts;
a second set of fasteners secured through the second array of fastener openings in the anchor plate, the second shell member and the splice plate and each engaged with a corresponding one of the inserts; and
a third set of fasteners secured through the fastener openings of the anchor plate attachment features and the first shell member.

2. The assembly of claim 1, wherein the first shell member and the second shell member each comprises a composite material, wherein the splice plate comprises a metallic material, and wherein the anchor plate comprises a metallic material.

3. The assembly of claim 2, wherein the composite material includes reinforcement fibers.

4. The assembly of claim 1, wherein the first array of fastener openings and the second array of fastener openings are each arranged in a row.

5. The assembly of claim 1, wherein each fastener opening of the first array of fastener openings and the second array of fastener openings defines a boss that extends from the body portion of the anchor plate.

6. The assembly of claim 1, wherein the body portion of the anchor plate defines a substantially rectangular perimeter.

7. The assembly of claim 1, wherein each of the plurality of anchor plate attachment features has a substantially circular shape.

8. The assembly of claim 1, wherein the inserts are threaded, and wherein the first and second sets of fasteners are configured to threadably engage the inserts.

9. The assembly of claim 1, wherein at least the second set of fasteners is configured for blind engagement and disengagement from a location proximate the splice plate.

10. A method comprising:
positioning a first anchor plate adjacent to an interior surface of a first duct segment;
securing the first anchor plate to the first duct segment with a plurality of first fasteners;
positioning a second duct segment adjacent to the first duct segment;
positioning a splice plate adjacent to exterior surfaces of the first duct segment and the second duct segment; and
securing the first anchor plate, the first duct segment, the second duct segment and the splice plate together using additional fasteners in a blind engagement configuration.

11. The method of claim 10 and further comprising:
removing at least some of the additional fasteners from a location proximate the exterior surfaces of the second duct segment; and
moving the second duct segment away from the first duct segment.

12. The method of claim 10, wherein the step of positioning the splice plate adjacent to at least the exterior surface of the first duct segment covers the plurality of first fasteners with the splice plate at the exterior surface of the first duct segment.

13. The method of claim 10 and further comprising:
positioning a second anchor plate adjacent to an interior surface of the second duct segment;
securing the second anchor plate to the second duct segment with a plurality of second fasteners before positioning the second duct segment adjacent to the first duct segment; and
securing the second anchor plate to the second duct segment and the splice plate using at least some of the additional fasteners in a blind engagement configuration.

14. The method of claim 10, wherein the step of securing the first anchor plate to the first duct segment with a plurality of first fasteners comprises riveting.

15. The method of claim 10, wherein the first anchor plate is positioned to extend adjacent to an interior surface of the second duct segment.

16. An assembly comprising:
a first shell member;
a second shell member positioned adjacent to the first shell member;
a splice plate extending across portions of both the first shell member and the second shell member;
a first anchor plate located opposite the splice plate and positioned relative the first shell member, and comprising a plurality of first fastener openings and a plurality of second fastener openings;
a second anchor plate located opposite the splice plate and positioned relative the second shell member, and comprising a plurality of third fastener openings and a plurality of fourth fastener openings;
an insert positioned within at least the first and third fastener openings, wherein each insert is rotationally locked;
a first set of fasteners secured through the first fastener openings of the first anchor plate, the first shell member and the splice plate and each engaged with a corresponding one of the inserts;
a second set of fasteners secured through the third fastener openings of the second anchor plate, the second shell member and the splice plate and each engaged with a corresponding one of the inserts;
a third set of fasteners secured through the second fastener openings of first anchor plate and the first shell member, wherein the splice plate covers the third set of fasteners; and
a fourth set of fasteners secured through the fourth fastener openings of second anchor plate and the second shell member, wherein the splice plate covers the fourth set of fasteners.

17. The assembly of claim 16, wherein the first shell member and the second shell member each comprises a composite material, wherein the splice plate comprises a metallic material, and wherein the anchor plate comprises a metallic material.

18. The assembly of claim 17, wherein the composite material includes reinforcement fibers.

19. The assembly of claim 16, wherein the first fastener openings are configured in two rows staggered relative to each other.

20. The assembly of claim 16, wherein each fastener opening of the first array of fastener openings and the second array of fastener openings defines a boss that extends from the body portion of the anchor plate.

21. The assembly of claim 16, wherein first and second sets of fasteners comprise threaded fasteners, and wherein the third and fourth sets of fasteners comprise rivets.

22. The assembly of claim 16, wherein the first shell member defines one or more countersunk recesses to accommodate a portion of the third set of fasteners.
